(19) United States
(12) Patent Application Publication
(10) Pub. No.: US 2015/0115547 A1
(43) Pub. Date: Apr. 30, 2015

(54) Seal with Tabs for Retaining Energizing Member

(71) Applicants: Timothy H. Rushton, Farr West, UT (US); Anthony Todd Hagen, Murray, UT (US)

(72) Inventors: Timothy H. Rushton, Farr West, UT (US); Anthony Todd Hagen, Murray, UT (US)

(73) Assignee: AKTIEBOLAGET SKF, Goteborg (SE)

(21) Appl. No.: 14/061,801

(22) Filed: Oct. 24, 2013

(51) Int. Cl. F16J 15/02

(52) U.S. Cl. CPC F16J 15/021
USPC 277/637

(57) ABSTRACT

A seal for sealing between inner and outer bodies includes a generally annular sealing member having inner and outer circumferential sealing surfaces, at least one of the inner and outer sealing surfaces being sealingly engageable with one of the inner body outer surface and the outer body inner surface. The sealing member further has an interior surface at least partially defining a generally annular interior cavity, an opening extending into the cavity, and at least one locking tab extending from the interior surface and into the cavity. An annular biasing member is disposed within the sealing member cavity and configured to bias the at least one sealing surface generally toward the at least body surface. The biasing member has at least one engagement recess configured to receive at least a portion of the at least one locking tab such that the biasing member is retained within the cavity.

The present invention relates to seals, and more particularly to seals for sealing annular spaces between inner and outer bodies

Seals for sealing annular spaces are generally known. One type of known seal includes an annular body having inner and outer circumferential surfaces which seal against proximal circumferential surfaces of an inner body and an outer body disposed coaxially about the inner body. Typically, such a seal includes a rigid polymeric sealing member with inner and outer walls bounding an annular cavity and an elastomeric biasing or energizing member disposed within the annular cavity. The energizing member tends to push the two walls away from each other and into sealing contact with the inner and outer bodies.

Generally, the polymeric sealing member is treated with etchants to make the surfaces of the cavity capable of bonding to the energizing member, and then an adhesive is applied between the prepared surfaces of the sealing member and the outer surfaces of the elastomeric energizing member. After bonding, excess etchant is typically removed with solvents or by a mechanical means (e.g., grinding).

### SUMMARY OF THE INVENTION

In one aspect, the present invention is a seal for sealing between an inner body and an outer body, the inner body having an outer circumferential surface and the outer member having an inner circumferential surface spaced radially from the inner surface so as to define a generally annular space. The seal comprises a generally annular sealing member having inner and outer circumferential sealing surfaces, at least one of the inner and outer sealing surfaces being sealingly engageable with one of the inner body outer surface and the outer body inner surface.

The sealing member further has an interior surface at least partially defining a generally annular interior cavity, an opening extending into the cavity, and at least one locking tab extending from the interior surface and into the cavity. An annular biasing member is disposed within the sealing member cavity, is configured to bias the at least one sealing surface generally toward the at least body surface, and has at least one engagement recess configured to receive at least a portion of the at least one locking tab such that the biasing member is retained within the cavity.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is broken-away, perspective view of a seal in accordance with the present invention;

FIG. 2 is a broken-away, axial cross-sectional view of the seal;

FIG. 3 is a broken-away, axial cross-sectional view of a sealing member of the seal assembly;

FIG. 4 is a broken-away, axial cross-sectional view of a biasing member of the seal assembly;

FIG. 5 is an enlarged broken-away, axial cross-sectional view of a portion of the sealing member, showing the preferred structure of locking tabs;

FIG. 6 is an enlarged broken-away, axial cross-sectional view of a portion of the biasing member, showing the preferred structure of engagement recesses;

FIG. 7 is an enlarged, broken-away, axial cross-sectional view of the seal, showing the engagement of the tabs and recesses; and

FIG. 8 is another broken-away, axial cross-sectional view of the seal, shown during installation of the biasing member within the sealing member.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

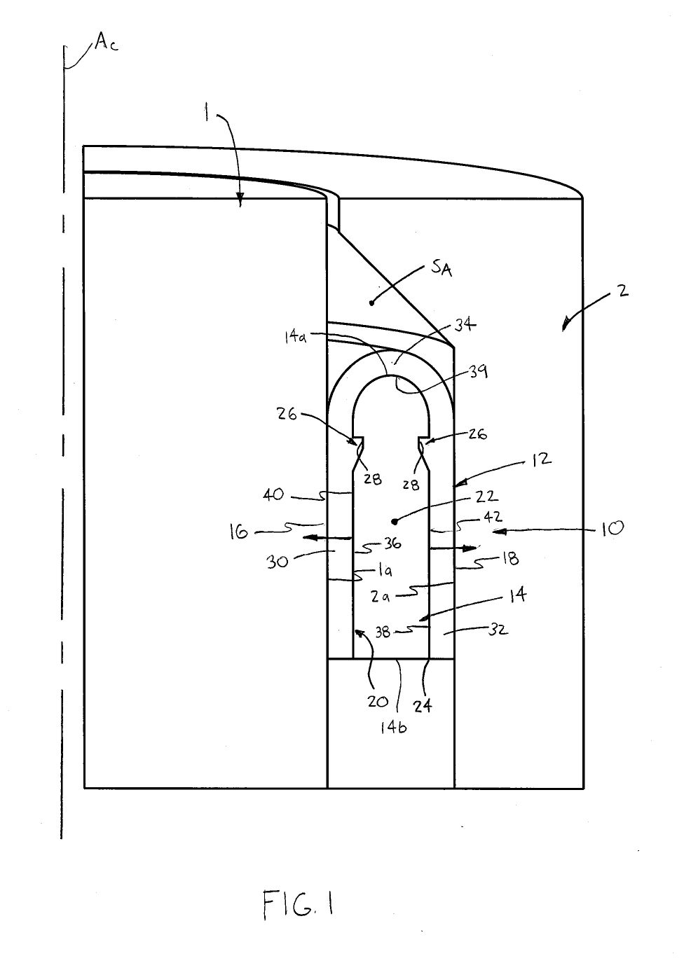

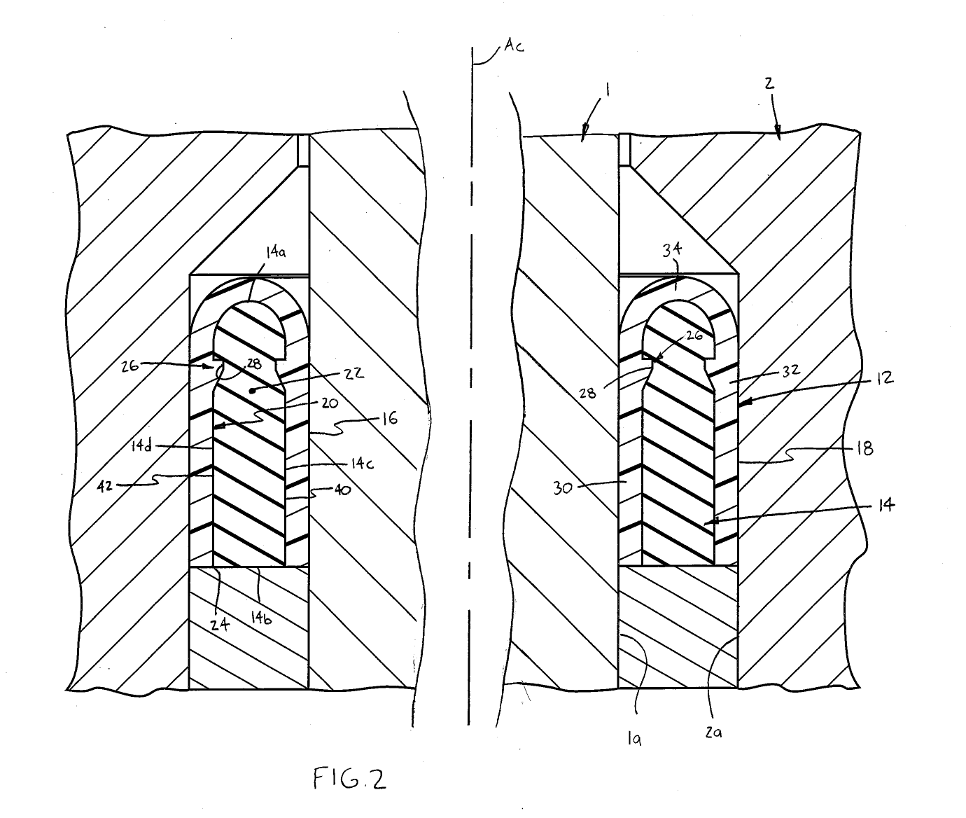

Referring now to the drawings in detail, wherein like numbers are used to indicate like elements throughout, there is shown in FIGS. 1-8 a seal 10 for sealing between an inner body 1 and an outer body 2, the inner body 1 having an outer circumferential surface la and the outer body 2 having an inner circumferential surface 2a spaced radially from the inner surface 1 a so as to define a generally annular space S_{A}. In one presently preferred application, the inner body 1 is a stem of a gate valve and the outer body 2 is a gland of the valve, but the seal 10 may be used with any other types of bodies 1, 2 for which the sealing of a generally annular space is required. The seal 10 has a central axis A_{C} and basically comprises a generally annular sealing member 12, preferably formed of a generally rigid polymeric material (e.g., PTFE) and a generally annular “energizing” or biasing member 14 disposed within the sealing member 12, which is preferably formed of an elastomeric material such as natural or synthetic rubber.

The sealing member 12 has inner and outer circumferential sealing surfaces 16, 18, respectively, the inner surface 16 being sealingly engageable with the inner body outer surface 1a and the outer sealing surface 18 being sealingly engageable with the outer body inner surface 2a. The sealing member 12 also has an interior surface 20 at least partially defining a generally annular interior cavity 22, an opening 24 extending into the cavity 22, and at least one locking tab 26 extending from the interior surface 20 and into the cavity 22. Further, the biasing member 14 is disposed within the sealing member cavity 22 and is configured to bias at least one of the sealing surfaces 16, 18, and preferably both, generally toward the proximal body surface 1a, 2a, respectively. Also, the biasing member 14 has at least one engagement recess 28 configured to receive at least a portion of the at least one locking tab 26, such that the biasing member 14 is thereby retained within the cavity 22.

Preferably, the sealing member 12 is formed as a generally shell-like body having generally U-shaped axial cross-sections. Specifically, the sealing member 12 includes inner and outer side walls 30, 32 extending circumferentially about the seal central axis A_{C} and bounding the interior cavity 22, and a curved, central end wall 34 extending between the inner and outer side walls 30, 32. Each side wall 30, 32 has a free end 30a, 32a, respectively, with the sealing member opening 24 being defined between the ends 30a, 32b. The inner side wall 30 provides the inner circumferential sealing surface 16, which defines a central bore 17 that is preferably sized to receive a portion of the gate valve stem 1, a discussed above, and further has an opposing outer circumferential surface section 36 providing a portion of the body interior surface 20. The outer side wall 32 provides the outer circumferential sealing surface 18 and is disposed coaxially about the inner wall 30. Further, the outer side wall 32 has an inner circumferential surface section 38 facing generally toward, and spaced radially outwardly from, the inner wall outer surface 34 and providing another portion of the body interior surface 20. Also, the curved, central end wall 34 extends generally radially between and integrally connects inner ends 30b, 32b of the two side walls 30, 32 and has a curved radial surface section 39. Thus, the sealing member cavity 22 is therefore defined by the three surface sections 36, 38 and 39 providing the sealing member interior surface 20.

Furthermore, the biasing member 14 is preferably formed as a generally solid, annular body or ring having first and second axial ends 14a, 14b and inner and outer circumferential surfaces 40, 42 extending about the central axis A_{C}. The biasing member 14 is sized to fit within the sealing member cavity 22, with the first, inner end 14a being generally curved to fit against the curved surface 39 of the sealing member end wall 34 and the second, outer end 14b being generally flat, and has an axial length (i.e., between the ends 14a, 14b) such that the second end 14b is disposed within the sealing member opening 24. Further, the biasing member 14 has a radial thickness t_{R} (i.e., the perpendicular distance between circumferential surfaces 40, 42) with a magnitude such that the biasing member 14 is compressed within the cavity 22.

As such, biasing member 14 preferably biases both side walls 30, 32 in opposing radial directions to seal against the surfaces 1a, 2a of the inner and outer bodies 1, 2, respectively. That is, the biasing member 14 preferably biases the inner side wall 30 in a generally radially inwardly direction so that the sealing member inner surface 16 sealingly engages with the inner body outer surface la with a contact pressure. The biasing member 14 preferably also biases the outer side wall 32 in a generally radially outwardly direction such that the sealing member outer surface 18 sealingly engages with the outer body inner surface 2a with contact pressure. Alternatively, the sealing member 12 may be formed such that one of the side walls 30 or 32 engages with the associated body surface 1a, 2a, respectively, with a friction or interference fit and only the other side wall 32 or 30 is biased into sealing engagement with the associated body surface 2a, 1a.

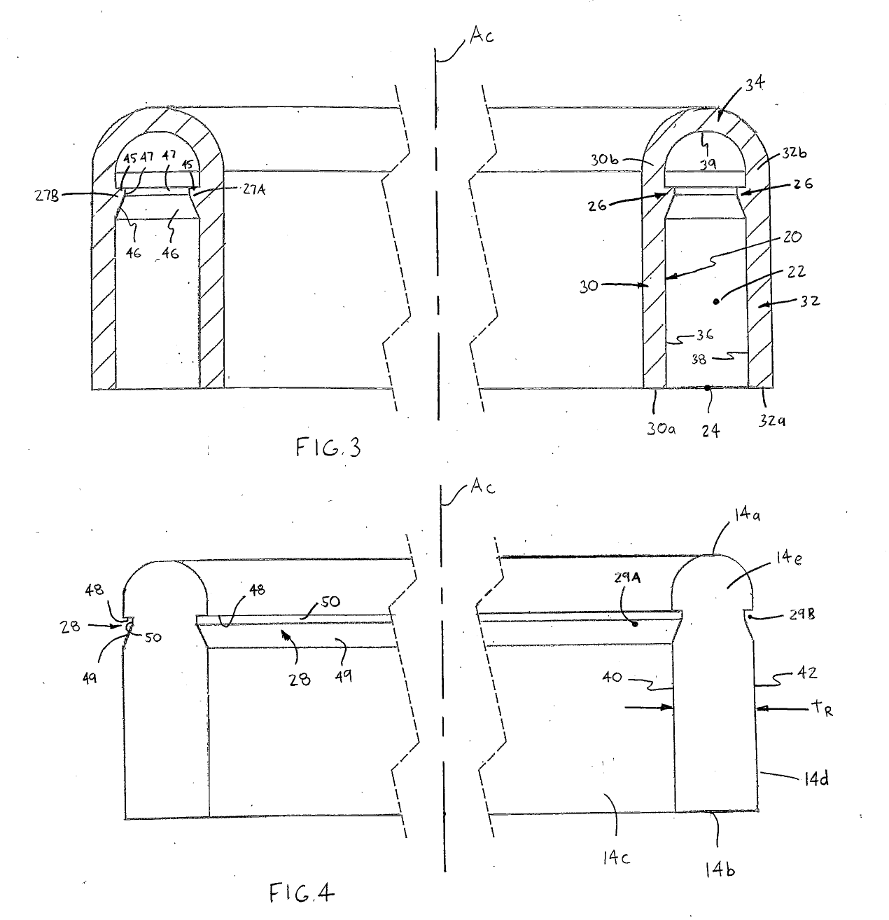

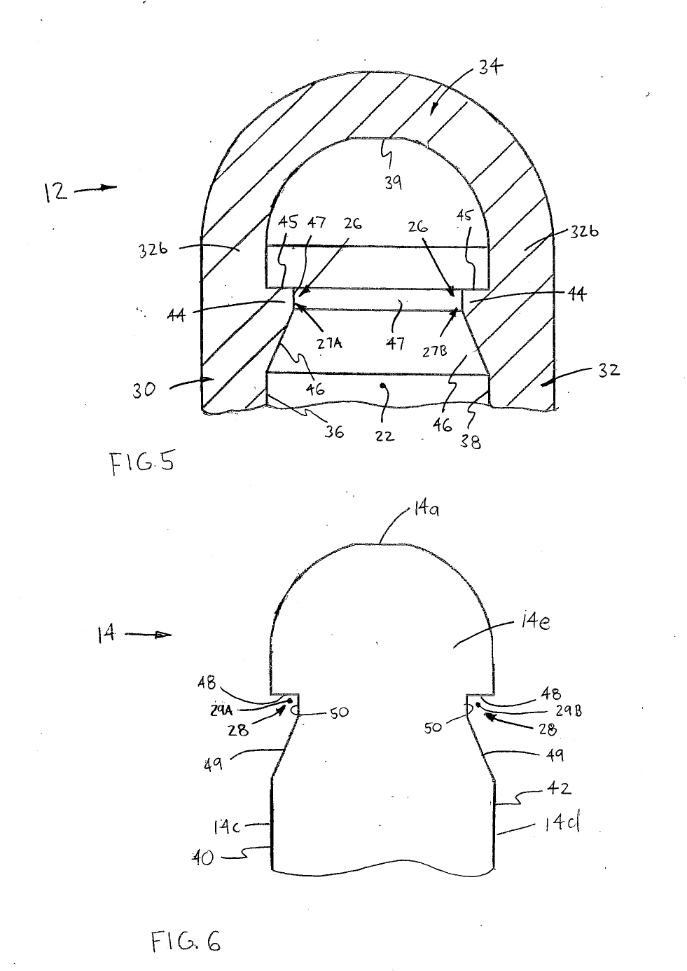

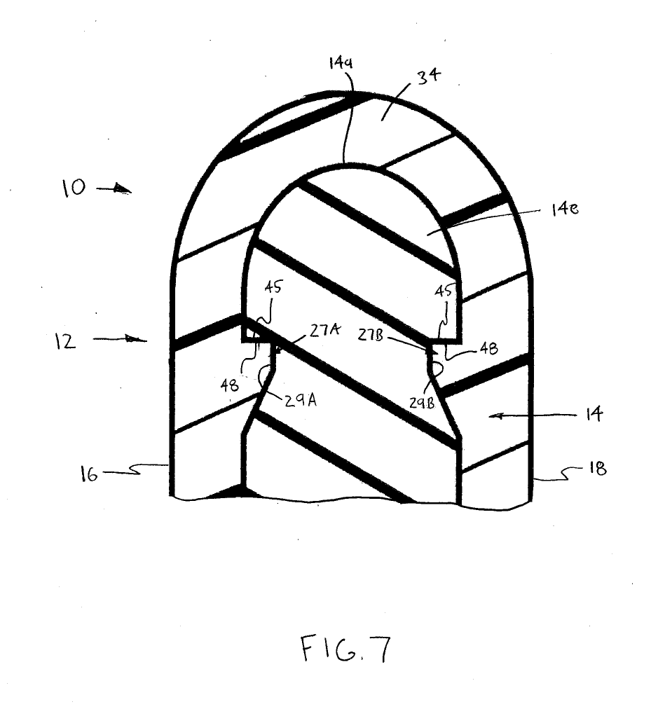

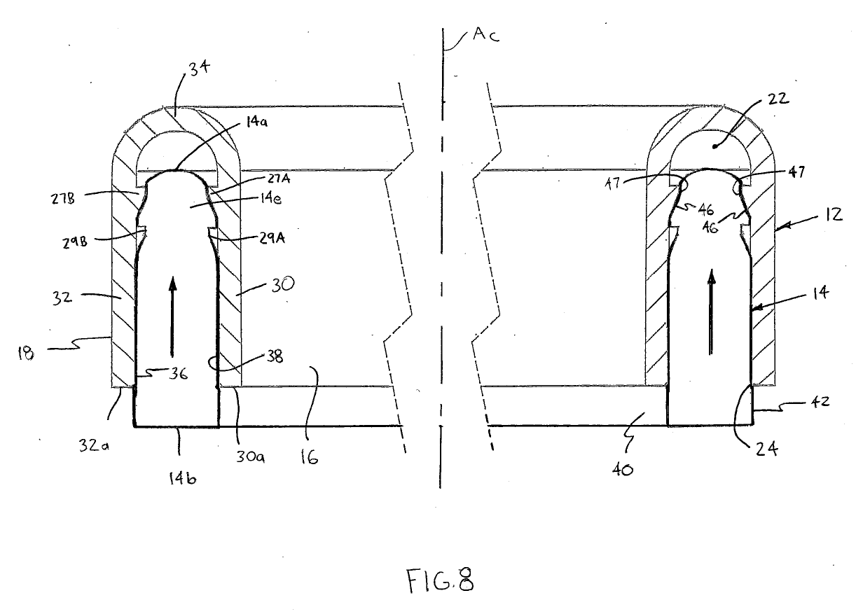

Referring to FIGS. 3-7, the at least one locking tab 26 of the sealing member 12 extends generally radially with respect to the central axis A_{C} from either the inner wall outer surface 36 or from the outer wall inner surface 38. Correspondingly, the at least one engagement recess 28 of the biasing member 14 extends generally radially from one of the circumferential surfaces 40, 42, i.e., the one proximal to the one locking tab 26. Preferably, the sealing member 12 has both an inner locking tab 27A extending radially outwardly from the inner wall outer surface 36 and an outer locking tab 27B extending radially inwardly from the outer wall inner surface 38. With this structure, the biasing member 14 preferably includes both an inner recess 29A and an outer recess 29B. The inner recess 29A extends radially outwardly from the biasing member inner circumferential surface 40 and is configured to receive the inner locking tab 27A. Further, the outer recess 29B extends radially inwardly from the biasing member outer circumferential surface 42 and is configured to receive the outer locking tab 27B. Thus, with the two preferred locking tabs 27A, 27B and two engagement recesses 29A, 29B, the biasing member 14 is securely retained within the sealing member cavity 22 by engagement at the inner and outer radial ends 14c, 14d. However, the seal 10 may alternatively be formed with only a single locking tab/engagement recess coupling (e.g., inner tab 27A and inner recess 29A).

Referring to FIGS. 3 and 4, each locking tab 27A, 27B is preferably formed as a continuous, generally annular shoulder 44 extending circumferentially about the seal central axis A_{C} and either radially outwardly from the outer surface 36 of the inner side wall 30 or radially inwardly from the inner surface 38 of the outer side wall 32. Correspondingly, each engagement recess 29A, 29B is preferably formed as a continuous, generally annular recess extending circumferentially about the seal central axis A_{C} and either radially outwardly from the biasing member inner surface 40 or radially inwardly from the biasing member outer surface 42. Although the locking tabs and recesses each preferably extend substantially continuously about the central axis A_{C}, the locking tabs 27A, 27B may each be formed as a plurality of circumferentially spaced arcuate segments (not shown), with the recesses 29A, 29B being either correspondingly segmented (not shown) or continuous (as depicted).

Referring now to FIGS. 5-7, each locking tab shoulder 44 is preferably formed having a generally radially-extending retainer surface 45 facing generally toward the sealing member central wall 34, an angled guide surface 46 facing generally toward the sealing member opening 24, and a circumferential edge surface 47 extending axially between the retainer and guide surfaces 45, 46. Each engagement recess 28 is preferably defined by a generally radially-extending contact surface 48 facing generally toward the biasing member second axial end 14b, and thus toward the sealing member opening 24, an angled surface 49 facing generally toward the biasing member first axial end 14a (and thus the sealing member end wall 34), and a circumferential surface 50 extending axially between the retainer and angled surfaces 48, 49. With this structure, when the biasing member 14 is disposed within the sealing member 12, the engagement recess contact surface 48 is disposed against the locking tab retainer surface 45. Due to the described orientation of the two surfaces 45, 48, the engagement of the retainer surface 45 and contact surface 48 prevents displacement of the biasing member 14 in an axial direction generally toward the sealing member opening 24 and generally away from the sealing member central end wall 34, thereby retaining the biasing member 14 with the sealing member cavity 22.

Referring specifically to FIG. 8, the biasing member 14 is installed within the sealing member cavity 22 in the following manner. The biasing member first axial end 14a is first positioned generally adjacent to the sealing member opening 24, and then the biasing member 14 is displaced generally axially through the sealing member opening 24 and generally toward the sealing member central wall 34. At a certain position, a portion of the biasing member inner circumferential surface 40 slides along the angled surface 46 of the inner locking tab 27A as a portion of the biasing member outer circumferential surface 42 slides along the angled surface 46 of the outer locking tab 27B, as depicted in FIG. 8. Such movement of the biasing member 14 along the tab angled surfaces 46 and then along the tab edge surfaces 47 compresses or squeezes an inner portion 14e of the biasing member 14 between the two tabs 27A, 27B, and may also causes a slight displacement the tabs 27A, 27B and the sidewalls 30, 32 in radial directions away from the biasing member 14, until the inner portion 14e passes entirely between the tab edge surfaces 47 and the tabs 27A, 27B are axially aligned with the biasing member recesses 29A, 29B. At this point, the tabs 27A, 27B enter and become disposed within the engagement recesses 29A, 29B, such that the biasing member 14 is thereby secured within the sealing member cavity 22. The seal 10 is then ready for installation in a desired application, e.g., to seal between a stem and gland of a gate valve.

The seal 10 of the present invention has clear advantages over similar known seal assemblies. By using mechanical means (i.e., locking tabs and recesses) to retain the biasing member 14 within the sealing member 12, the use of chemicals such as etchants to prepare the surface 20 of the cavity 22, adhesives to bond the sealing member 12 to the biasing member 14, and solvents to remove excess etchants, is entirely eliminated. Thus, the usage of substances with potentially adverse environmental effects is minimized in the manufacturing of the seal 10. Further, the use of the locking tabs 27A, 27B pre-formed in the sealing member 12 and engagement recesses 29A, 29B pre-formed in the biasing member 14 eliminates the steps of preparing the sealing member surfaces 36, 38, 39 for bonding, bonding the sealing member 12 to the biasing member 14 with adhesives, and removing the excess etchants, which thus reduces manufacturing time and cost.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A seal for sealing between an inner body and an outer body, the inner body having an outer circumferential surface and the outer member having an inner circumferential surface spaced radially from the inner surface so as to define a generally annular space, the seal comprising:
a generally annular sealing member having inner and outer circumferential sealing surfaces, at least one of the inner and outer sealing surfaces being sealingly engageable with one of the inner body outer surface and the outer body inner surface, an interior surface at least partially defining a generally annular interior cavity, an opening extending into the cavity, and at least one locking tab extending from the interior surface and into the cavity; and
an annular biasing member disposed within the sealing member cavity, configured to bias the at least one sealing surface generally toward the at least body surface, and having at least one engagement recess configured to receive at least a portion of the at least one locking tab such that the biasing member is retained within the cavity.

2. The seal as recited in claim 1 wherein the seal has a central axis and the sealing member includes an inner side wall extending circumferentially about the central axis and having an outer circumferential surface, an outer side wall extending circumferentially about the axis, disposed coaxially about the inner wall and having an inner circumferential surface facing generally toward the inner wall outer surface, and a central, generally radial wall extending between and integrally connecting the inner and outer side walls, the at least one locking tab extending radially with respect to the central axis from one of the inner wall outer surface and the outer wall inner surface.

3. The seal as recited in claim 2 wherein:
the at least one locking tab of the sealing member includes an inner locking tab extending radially outwardly from the inner wall outer surface and an outer locking tab extending radially inwardly from the outer wall inner surface; and
the biasing member has inner and outer circumferential surfaces and the at least one recess of the sealing member includes an inner recess extending radially outwardly from the inner circumferential surface and configured to receive the inner locking tab and an outer recess extending radially inwardly from the outer circumferential surface and configured to receive the outer locking tab.

4. The seal as recited in claim 2 wherein:
the at least one locking tab is formed as a generally annular shoulder extending circumferentially about the seal central axis and radially from one of the inner wall outer circumferential surface and the outer wall inner circumferential surface; and
the biasing member has inner and outer circumferential surfaces and the at least one recess is formed as a generally annular recess extending circumferentially about the seal central axis and one of radially outwardly from the biasing member inner surface and radially inwardly from the biasing member outer surface.

5. The seal as recited in claim 4 wherein the shoulder of the at least one locking tab shoulder has a generally radially-extending retainer surface facing generally toward the sealing member central wall and the at least one engagement recess has a generally radially-extending contact surface facing generally toward the sealing member opening and disposed against the locking tab retainer surface such that engagement of the retainer surface and contact surface prevents displacement of the sealing member in an axial direction generally away from the sealing member central wall.

6. The seal as recited in claim 4 wherein the shoulder of the at least one locking tab further has an angled surface facing generally toward the sealing member opening and the biasing member is installed within the sealing member cavity by displacing the biasing member axially through the sealing member opening and generally toward the sealing member central wall such that one of the biasing member outer surface and the biasing member inner surface slides along the angled surface of the at least one locking tab until the at least one locking tab aligns axially with and becomes disposed within the at least one engagement recess.

7. The seal as recited in claim 1 wherein:
the sealing member has inner and outer side walls extending circumferentially about the seal central axis and bounding the interior cavity, the inner side wall providing the inner circumferential surface and the outer side wall providing the outer circumferential surface; and
the biasing member has a radial thickness with a magnitude such that the biasing member is compressed within the cavity and biases the inner side wall in a generally radially inwardly direction so that the sealing member inner surface sealingly engages with the inner body outer surface and biases the outer side wall in a generally radially outwardly direction such that the sealing member outer surface sealingly engages with the outer body inner surface.

8. The seal as recited in claim 1 wherein the sealing member is formed of a generally rigid polymeric material and the biasing member is formed of an elastomeric material.

9. The seal as recited in claim 1 wherein the inner body is a stem of a gate valve and the sealing member inner circumferential surface defines a central bore sized to receive a portion of the gate valve stem.
